(19) United States
(12) Patent Application Publication
(10) Pub. No.: US 2024/0103611 A1
(43) Pub. Date: Mar. 28, 2024

(54) Method and Device for Waking a Computing System

(71) Applicant: Apple Inc., Cupertino, CA (US)

(72) Inventor: Gregory Lutter, Boulder Creek, CA (US)

(21) Appl. No.: 18/369,328

(22) Filed: Sep. 18, 2023

Related U.S. Application Data
(60) Provisional application No. 63/408,998, filed on Sep. 22, 2022.

(51) Int. Cl. G06F 3/01

(52) U.S. Cl. CPC G06F 3/012; G06F 3/013

(57) ABSTRACT

In one implementation, a method for transitioning from a sleep mode to an active mode. The method includes: while operating the computing system according to a first mode, obtaining head pose information associated with a user of the computing system; in accordance with a determination that the head pose information satisfies a first wake criterion: presenting, via the display device, a wake target; and obtaining a gaze vector associated with the user of the computing system; and in accordance with a determination that the gaze vector satisfies a second wake criterion, transitioning the computing system from the first mode to a second mode different from the first mode.

### CROSS-REFERENCE TO RELATED APPLICATIONS

This application is claims priority to U.S. Provisional Patent App. No. 63/408,998, filed on Sep. 22, 2022, which is hereby incorporated by reference in its entirety.

### TECHNICAL FIELD

The present disclosure generally relates to waking a computing system and, in particular, to systems, devices, and methods for transitioning from a sleep mode to an active mode.

### BACKGROUND

Maintaining a computing system in a constant active state generates thermal load, consumes computing and memory resources, and also drains power/battery reserves. As such, the computing system may enter a sleep or suspended state after some period of inactivity. A wake input may trigger a transition from the sleep state to an active state. Typical wake inputs may correspond to a predefined voice input or the like, which may still require some sensors to remain active.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating architecture in accordance with some implementations.

FIG. 2 is a block diagram of an example controller in accordance with some implementations.

FIG. 3 is a block diagram of an example electronic device in accordance with some implementations.

FIG. 4A is a block diagram of an example input processing architecture in accordance with some implementations.

FIG. 4B is a block diagram of an example content delivery architecture in accordance with some implementations.

FIGS. 5A-5F illustrate an example sequence of instances for waking a computing system in accordance with some implementations.

FIGS. 6A-6D illustrate another example sequence of instances for waking a computing system in accordance with some implementations.

FIG. 7 illustrates various attractor scenarios associated with the wake region in FIGS. 5A-5F and 6A-6D in accordance with some implementations.

FIG. 8 illustrates a flowchart representation of a method of transitioning from a sleep mode to an active mode in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### SUMMARY

Various implementations disclosed herein include devices, systems, and methods for transitioning from a sleep mode to an active mode. According to some implementations, the method is performed at a computing system including non-transitory memory and one or more processors, wherein the computing system is communicatively coupled to a display device and one or more input devices. The method includes: while operating the computing system according to a first mode, obtaining head pose information associated with a user of the computing system; in accordance with a determination that the head pose information satisfies a first wake criterion: presenting, via the display device, a wake target; and obtaining a gaze vector associated with the user of the computing system; and in accordance with a determination that the gaze vector satisfies a second wake criterion, transitioning the computing system from the first mode to a second mode different from the first mode.

In accordance with some implementations, an electronic device includes one or more displays, one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more displays, one or more processors, a non-transitory memory, and means for performing or causing performance of any of the methods described herein.

In accordance with some implementations, a computing system includes one or more processors, non-transitory memory, an interface for communicating with a display device and one or more input devices, and one or more programs; the one or more programs are stored in the non-transitory memory and configured to be executed by the one or more processors and the one or more programs include instructions for performing or causing performance of the operations of any of the methods described herein. In accordance with some implementations, a non-transitory computer readable storage medium has stored therein instructions which when executed by one or more processors of a computing system with an interface for communicating with a display device and one or more input devices, cause the computing system to perform or cause performance of the operations of any of the methods described herein. In accordance with some implementations, a computing system includes one or more processors, non-transitory memory, an interface for communicating with a display device and one or more input devices, and means for performing or causing performance of the operations of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

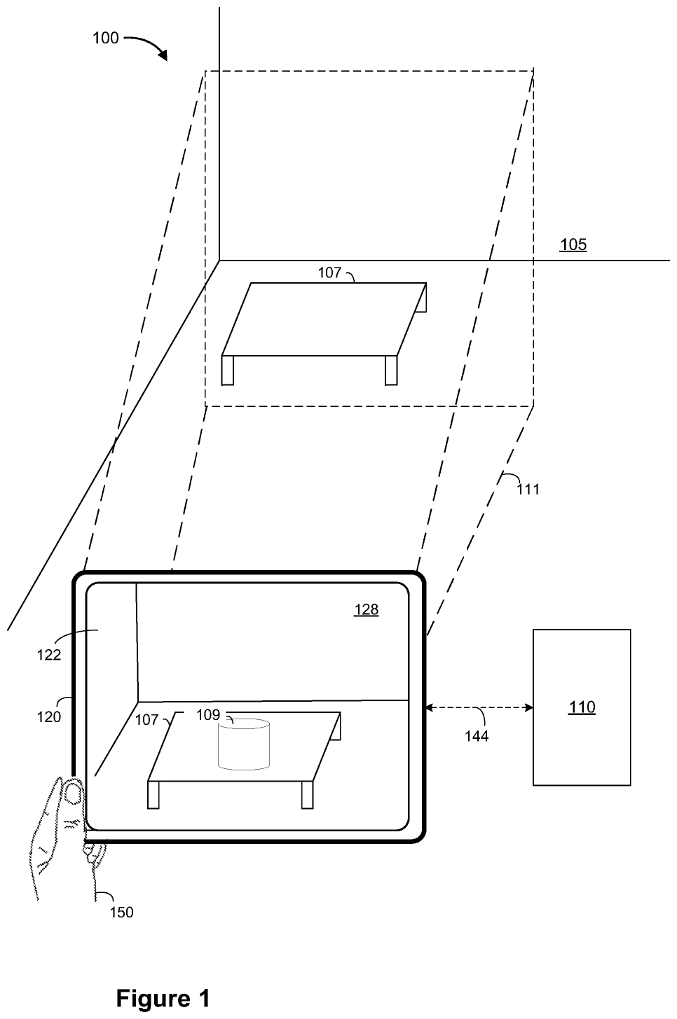

FIG. 1 is a block diagram of an example operating architecture 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating architecture 100 includes an optional controller 110 and an electronic device 120 (e.g., a tablet, mobile phone, laptop, near-eye system, wearable computing device, or the like).

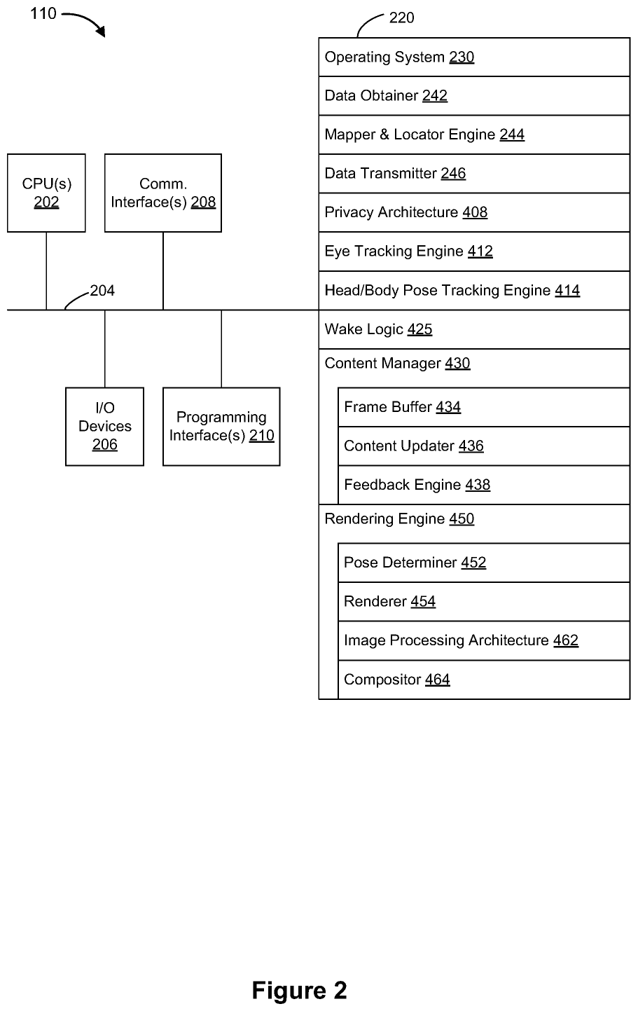

In some implementations, the controller 110 is configured to manage and coordinate an XR experience (sometimes also referred to herein as a “XR environment” or a “virtual environment” or a “graphical environment”) for a user 150 and optionally other users. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In some implementations, the functions of the controller 110 are provided by the electronic device 120. As such, in some implementations, the components of the controller 110 are integrated into the electronic device 120.

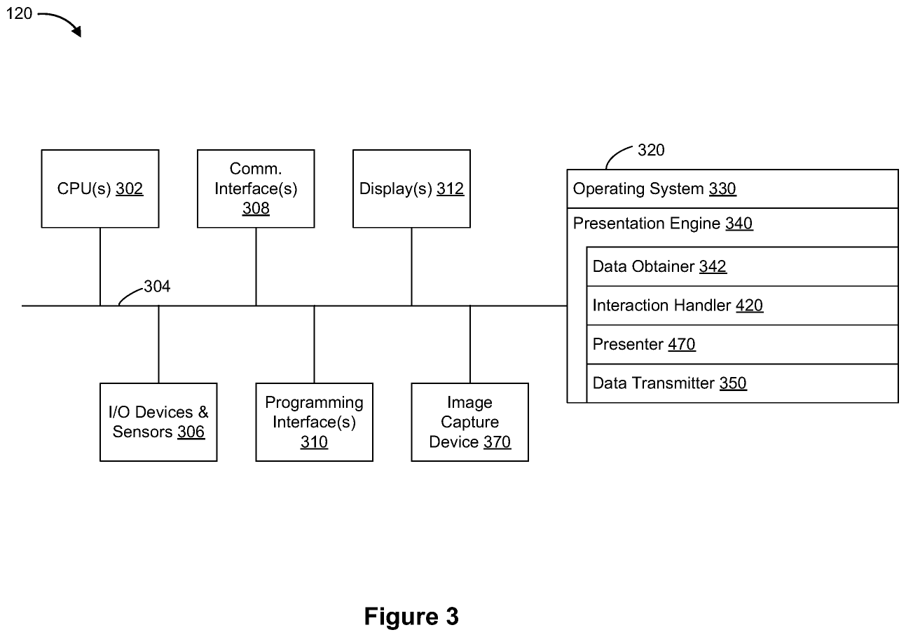

In some implementations, the electronic device 120 is configured to present audio and/or video (A/V) content to the user 150. In some implementations, the electronic device 120 is configured to present a user interface (UI) and/or an XR environment 128 to the user 150. In some implementations, the electronic device 120 includes a suitable combination of software, firmware, and/or hardware. The electronic device 120 is described in greater detail below with respect to FIG. 3.

According to some implementations, the electronic device 120 presents an XR experience to the user 150 while the user 150 is physically present within a physical environment 105 that includes a table 107 within the field-of-view (FOV) 111 of the electronic device 120. As such, in some implementations, the user 150 holds the electronic device 120 in his/her hand(s). In some implementations, while presenting the XR experience, the electronic device 120 is configured to present XR content (sometimes also referred to herein as “graphical content” or “virtual content”), including an XR cylinder 109, and to enable video pass-through of the physical environment 105 (e.g., including the table 107) on a display 122. For example, the XR environment 128, including the XR cylinder 109, is volumetric or three-dimensional (3D).

In one example, the XR cylinder 109 corresponds to head/display-locked content such that the XR cylinder 109 remains displayed at the same location on the display 122 as the FOV 111 changes due to translational and/or rotational movement of the electronic device 120. As another example, the XR cylinder 109 corresponds to world/object-locked content such that the XR cylinder 109 remains displayed at its origin location as the FOV 111 changes due to translational and/or rotational movement of the electronic device 120. As such, in this example, if the FOV 111 does not include the origin location, the displayed XR environment 128 will not include the XR cylinder 109. As another example, the XR cylinder 109 corresponds to body-locked content such that it remains at a positional and rotational offset from the body of the user 150. In some examples, the electronic device 120 corresponds to a near-eye system, mobile phone, tablet, laptop, wearable computing device, or the like.

In some implementations, the display 122 corresponds to an additive display that enables optical see-through of the physical environment 105 including the table 107. For example, the display 122 corresponds to a transparent lens, and the electronic device 120 corresponds to a pair of glasses worn by the user 150. As such, in some implementations, the electronic device 120 presents a user interface by projecting the XR content (e.g., the XR cylinder 109) onto the additive display, which is, in turn, overlaid on the physical environment 105 from the perspective of the user 150. In some implementations, the electronic device 120 presents the user interface by displaying the XR content (e.g., the XR cylinder 109) on the additive display, which is, in turn, overlaid on the physical environment 105 from the perspective of the user 150.

In some implementations, the user 150 wears the electronic device 120 such as a near-eye system. As such, the electronic device 120 includes one or more displays provided to display the XR content (e.g., a single display or one for each eye). For example, the electronic device 120 encloses the FOV of the user 150. In such implementations, the electronic device 120 presents the XR environment 128 by displaying data corresponding to the XR environment 128 on the one or more displays or by projecting data corresponding to the XR environment 128 onto the retinas of the user 150.

In some implementations, the electronic device 120 includes an integrated display (e.g., a built-in display) that displays the XR environment 128. In some implementations, the electronic device 120 includes a head-mountable enclosure. In various implementations, the head-mountable enclosure includes an attachment region to which another device with a display can be attached. For example, in some implementations, the electronic device 120 can be attached to the head-mountable enclosure. In various implementations, the head-mountable enclosure is shaped to form a receptacle for receiving another device that includes a display (e.g., the electronic device 120). For example, in some implementations, the electronic device 120 slides/snaps into or otherwise attaches to the head-mountable enclosure. In some implementations, the display of the device attached to the head-mountable enclosure presents (e.g., displays) the XR environment 128. In some implementations, the electronic device 120 is replaced with an XR chamber, enclosure, or room configured to present XR content in which the user 150 does not wear the electronic device 120.

In some implementations, the controller 110 and/or the electronic device 120 cause an XR representation of the user 150 to move within the XR environment 128 based on movement information (e.g., body pose data, eye tracking data, hand/limb/finger/extremity tracking data, etc.) from the electronic device 120 and/or optional remote input devices within the physical environment 105. In some implementations, the optional remote input devices correspond to fixed or movable sensory equipment within the physical environment 105 (e.g., image sensors, depth sensors, infrared (IR) sensors, event cameras, microphones, etc.). In some implementations, each of the remote input devices is configured to collect/capture input data and provide the input data to the controller 110 and/or the electronic device 120 while the user 150 is physically within the physical environment 105. In some implementations, the remote input devices include microphones, and the input data includes audio data associated with the user 150 (e.g., speech samples). In some implementations, the remote input devices include image sensors (e.g., cameras), and the input data includes images of the user 150. In some implementations, the input data characterizes body poses of the user 150 at different times. In some implementations, the input data characterizes head poses of the user 150 at different times. In some implementations, the input data characterizes hand tracking information associated with the hands of the user 150 at different times. In some implementations, the input data characterizes the velocity and/or acceleration of body parts of the user 150 such as his/her hands. In some implementations, the input data indicates joint positions and/or joint orientations of the user 150. In some implementations, the remote input devices include feedback devices such as speakers, lights, or the like.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a touchscreen, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof described below with respect to FIG. 2.

An operating system 230 includes procedures for handling various basic system services and for performing hardware dependent tasks.

In some implementations, a data obtainer 242 is configured to obtain data (e.g., captured image frames of the physical environment 105, presentation data, input data, user interaction data, camera pose tracking information, eye tracking information, head/body pose tracking information, hand/limb/finger/extremity tracking information, sensor data, location data, etc.) from at least one of the I/O devices 206 of the controller 110, the I/O devices and sensors 306 of the electronic device 120, and the optional remote input devices. To that end, in various implementations, the data obtainer 242 includes instructions and/or logic therefor, and heuristics and metadata therefor.

In some implementations, a mapper and locator engine 244 is configured to map the physical environment 105 and to track the position/location of at least the electronic device 120 or the user 150 with respect to the physical environment 105. To that end, in various implementations, the mapper and locator engine 244 includes instructions and/or logic therefor, and heuristics and metadata therefor.

In some implementations, a data transmitter 246 is configured to transmit data (e.g., presentation data such as rendered image frames associated with the XR environment, location data, etc.) to at least the electronic device 120 and optionally one or more other devices. To that end, in various implementations, the data transmitter 246 includes instructions and/or logic therefor, and heuristics and metadata therefor.

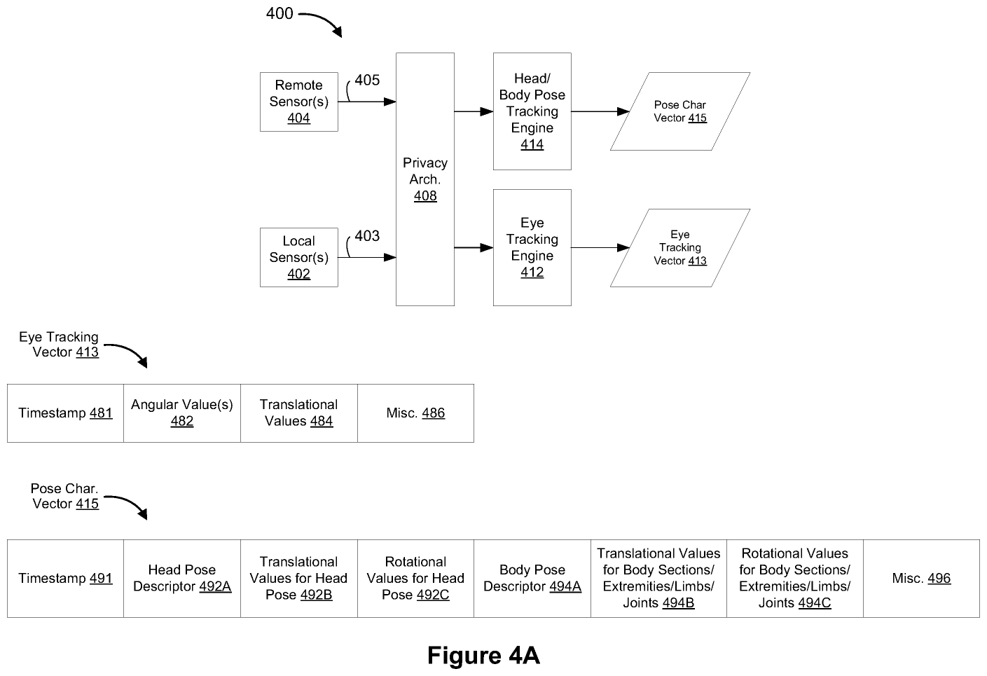

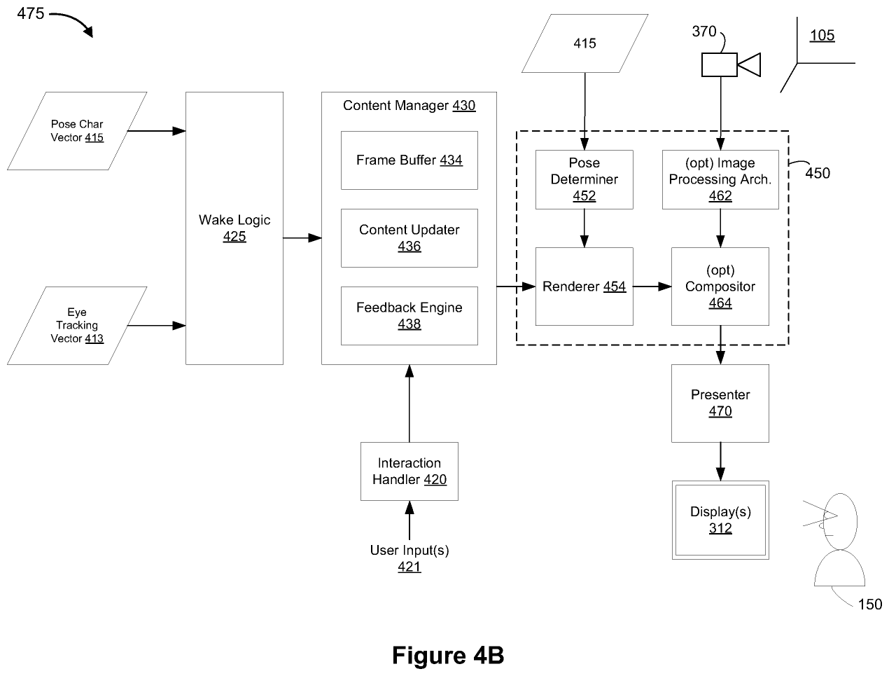

In some implementations, a privacy architecture 408 is configured to ingest data and filter user information and/or identifying information within the data based on one or more privacy filters. The privacy architecture 408 is described in more detail below with reference to FIG. 4A. To that end, in various implementations, the privacy architecture 408 includes instructions and/or logic therefor, and heuristics and metadata therefor.

In some implementations, an eye tracking engine 412 is configured to obtain (e.g., receive, retrieve, or determine/generate) an eye tracking vector 413 (sometimes also referred to herein as the “gaze vector 413”) as shown in FIG. 4A (e.g., with a gaze direction) based on the input data and update the eye tracking vector 413 over time. For example, the gaze direction indicates a point (e.g., associated with x, y, and z coordinates relative to the physical environment 105 or the world-at-large), a physical object, or a region of interest (ROI) in the physical environment 105 at which the user 150 is currently looking. As another example, the gaze direction indicates a point (e.g., associated with x, y, and z coordinates relative to the XR environment 128), an XR object, or a ROI in the XR environment 128 at which the user 150 is currently looking. The eye tracking engine 412 is described in more detail below with reference to FIG. 4A. To that end, in various implementations, the eye tracking engine 412 includes instructions and/or logic therefor, and heuristics and metadata therefor.

In some implementations, a head/body pose tracking engine 414 is configured to obtain (e.g., receive, retrieve, or determine/generate) a pose characterization vector 415 based on the input data and update the pose characterization vector 415 over time. For example, as shown in FIG. 4A, the pose characterization vector 415 includes a head pose descriptor 492A (e.g., upward, downward, neutral, etc.), translational values 492B for the head pose, rotational values 492C for the head pose, a body pose descriptor 494A (e.g., standing, sitting, prone, etc.), translational values 494B for body sections/extremities/limbs/joints, rotational values 494C for the body sections/extremities/limbs/joints, and/or the like. The head/body pose tracking engine 414 is described in more detail below with reference to FIG. 4A. To that end, in various implementations, the head/body pose tracking engine 414 includes instructions and/or logic therefor, and heuristics and metadata therefor. In some implementations, the eye tracking engine 412, and the head/body pose tracking engine 414 may be located on the electronic device 120 in addition to or in place of the controller 110.

In some implementations, wake logic 425 is configured to determine whether the eye tracking vector 413 and/or the pose characterization vector 415 satisfy first and second wake criteria for transitioning the electronic device 120 from a first mode (e.g., sleep mode) to a second mode (e.g., awake/active mode). The content wake logic 425 is described in more detail below with reference to FIG. 4B. To that end, in various implementations, the wake logic 425 includes instructions and/or logic therefor, and heuristics and metadata therefor.

In some implementations, a content manager 430 is configured to manage and update the layout, setup, structure, and/or the like for the XR environment 128 including one or more of VA(s), XR content, one or more user interface (UI) elements associated with the XR content, and/or the like. The content manager 430 is described in more detail below with reference to FIG. 4C. To that end, in various implementations, the content manager 430 includes instructions and/or logic therefor, and heuristics and metadata therefor. In some implementations, the content manager 430 includes a frame buffer 434, a content updater 436, and a feedback engine 438. In some implementations, the frame buffer 434 includes XR content, a rendered image frame, and/or the like for one or more past instances and/or frames.

In some implementations, the content updater 436 is configured to modify the XR environment 128 over time based on translational or rotational movement of the electronic device 120 or physical objects within the physical environment 105, the one or more user inputs 421 (e.g., a change in context, hand/extremity tracking inputs, eye tracking inputs, touch inputs, voice commands, modification/manipulation inputs with the physical object, and/or the like), and/or the like. To that end, in various implementations, the content updater 436 includes instructions and/or logic therefor, and heuristics and metadata therefor.

In some implementations, the feedback engine 438 is configured to generate sensory feedback (e.g., visual feedback such as text or lighting changes, audio feedback, haptic feedback, etc.) associated with the XR environment 128. To that end, in various implementations, the feedback engine 438 includes instructions and/or logic therefor, and heuristics and metadata therefor.

In some implementations, a rendering engine 450 is configured to render an XR environment 128 (sometimes also referred to herein as a “graphical environment” or “virtual environment”) or image frame associated therewith as well as the VA(s), XR content, one or more UI elements associated with the XR content, and/or the like. To that end, in various implementations, the rendering engine 450 includes instructions and/or logic therefor, and heuristics and metadata therefor. In some implementations, the rendering engine 450 includes a pose determiner 452, a renderer 454, an optional image processing architecture 462, and an optional compositor 464. One of ordinary skill in the art will appreciate that the optional image processing architecture 462 and the optional compositor 464 may be present for video pass-through configurations but may be removed for fully VR or optical see-through configurations.

In some implementations, the pose determiner 452 is configured to determine a current camera pose of the electronic device 120 and/or the user 150 relative to the A/V content and/or XR content. The pose determiner 452 is described in more detail below with reference to FIG. 4A. To that end, in various implementations, the pose determiner 452 includes instructions and/or logic therefor, and heuristics and metadata therefor.

In some implementations, the renderer 454 is configured to render the A/V content and/or the XR content according to the current camera pose relative thereto. The renderer 454 is described in more detail below with reference to FIG. 4A. To that end, in various implementations, the renderer 454 includes instructions and/or logic therefor, and heuristics and metadata therefor.

In some implementations, the image processing architecture 462 is configured to obtain (e.g., receive, retrieve, or capture) an image stream including one or more images of the physical environment 105 from the current camera pose of the electronic device 120 and/or the user 150. In some implementations, the image processing architecture 462 is also configured to perform one or more image processing operations on the image stream such as warping, color correction, gamma correction, sharpening, noise reduction, white balance, and/or the like. The image processing architecture 462 is described in more detail below with reference to FIG. 4A. To that end, in various implementations, the image processing architecture 462 includes instructions and/or logic therefor, and heuristics and metadata therefor.

In some implementations, the compositor 464 is configured to composite the rendered A/V content and/or XR content with the processed image stream of the physical environment 105 from the image processing architecture 462 to produce rendered image frames of the XR environment 128 for display. The compositor 464 is described in more detail below with reference to FIG. 4A. To that end, in various implementations, the compositor 464 includes instructions and/or logic therefor, and heuristics and metadata therefor.

Although the data obtainer 242, the mapper and locator engine 244, the data transmitter 246, the privacy architecture 408, the eye tracking engine 412, the head/body pose tracking engine 414, the wake logic 425, the content manager 430, and the rendering engine 450 are shown as residing on a single device (e.g., the controller 110), it should be understood that in other implementations, any combination of the data obtainer 242, the mapper and locator engine 244, the data transmitter 246, the privacy architecture 408, the eye tracking engine 412, the head/body pose tracking engine 414, the wake logic 425, the content manager 430, and the rendering engine 450 may be located in separate computing devices.

In some implementations, the functions and/or components of the controller 110 are combined with or provided by the electronic device 120 shown below in FIG. 3. Moreover, FIG. 2 is intended more as a functional description of the various features which may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 (e.g., a mobile phone, tablet, laptop, near-eye system, wearable computing device, or the like) in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations, the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more displays 312, an image capture device 370 (e.g., one or more optional interior- and/or exterior-facing image sensors), a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a magnetometer, a thermometer, one or more physiological sensors (e.g., blood pressure monitor, heart rate monitor, blood oximetry monitor, blood glucose monitor, etc.), one or more microphones, one or more speakers, a haptics engine, a heating and/or cooling unit, a skin shear engine, one or more depth sensors (e.g., structured light, time-of-flight, LiDAR, or the like), a localization and mapping engine, an eye tracking engine, a head/body pose tracking engine, a hand/limb/finger/extremity tracking engine, a camera pose tracking engine, and/or the like.

In some implementations, the one or more displays 312 are configured to present the XR environment to the user. In some implementations, the one or more displays 312 are also configured to present flat video content to the user (e.g., a 2-dimensional or “flat” AVI, FLV, WMV, MOV, MP4, or the like file associated with a TV episode or a movie, or live video pass-through of the physical environment 105). In some implementations, the one or more displays 312 correspond to touchscreen displays. In some implementations, the one or more displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more displays 312 correspond to diffractive, reflective, polarized, holographic, etc. waveguide displays. For example, the electronic device 120 includes a single display. In another example, the electronic device 120 includes a display for each eye of the user. In some implementations, the one or more displays 312 are capable of presenting AR and VR content. In some implementations, the one or more displays 312 are capable of presenting AR or VR content.

In some implementations, the image capture device 370 correspond to one or more RGB cameras (e.g., with a complementary metal-oxide-semiconductor (CMOS) image sensor or a charge-coupled device (CCD) image sensor), IR image sensors, event-based cameras, and/or the like. In some implementations, the image capture device 370 includes a lens assembly, a photodiode, and a front-end architecture. In some implementations, the image capture device 370 includes exterior-facing and/or interior-facing image sensors.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and a presentation engine 340.

The operating system 330 includes procedures for handling various basic system services and for performing hardware dependent tasks. In some implementations, the presentation engine 340 is configured to present media items and/or XR content to the user via the one or more displays 312. To that end, in various implementations, the presentation engine 340 includes a data obtainer 342, a presenter 470, an interaction handler 420, and a data transmitter 350.

In some implementations, the data obtainer 342 is configured to obtain data (e.g., presentation data such as rendered image frames associated with the user interface or the XR environment, input data, user interaction data, head tracking information, camera pose tracking information, eye tracking information, hand/limb/finger/extremity tracking information, sensor data, location data, etc.) from at least one of the I/O devices and sensors 306 of the electronic device 120, the controller 110, and the remote input devices. To that end, in various implementations, the data obtainer 342 includes instructions and/or logic therefor, and heuristics and metadata therefor.

In some implementations, the interaction handler 420 is configured to detect user interactions with the presented A/V content and/or XR content (e.g., gestural inputs detected via hand/extremity tracking, eye gaze inputs detected via eye tracking, voice commands, etc.). To that end, in various implementations, the interaction handler 420 includes instructions and/or logic therefor, and heuristics and metadata therefor.

In some implementations, the presenter 470 is configured to present and update A/V content and/or XR content (e.g., the rendered image frames associated with the user interface or the XR environment 128 including the VA(s), the XR content, one or more UI elements associated with the XR content, and/or the like) via the one or more displays 312. To that end, in various implementations, the presenter 470 includes instructions and/or logic therefor, and heuristics and metadata therefor.

In some implementations, the data transmitter 350 is configured to transmit data (e.g., presentation data, location data, user interaction data, head tracking information, camera pose tracking information, eye tracking information, hand/limb/finger/extremity tracking information, etc.) to at least the controller 110. To that end, in various implementations, the data transmitter 350 includes instructions and/or logic therefor, and heuristics and metadata therefor.

Although the data obtainer 342, the interaction handler 420, the presenter 470, and the data transmitter 350 are shown as residing on a single device (e.g., the electronic device 120), it should be understood that in other implementations, any combination of the data obtainer 342, the interaction handler 420, the presenter 470, and the data transmitter 350 may be located in separate computing devices.

Moreover, FIG. 3 is intended more as a functional description of the various features which may be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 4A is a block diagram of an example input processing architecture 400 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the input processing architecture 400 is included in a computing system such as the controller 110 shown in FIGS. 1 and 2; the electronic device 120 shown in FIGS. 1 and 3; and/or a suitable combination thereof.

As shown in FIG. 4A, one or more local sensors 402 of the controller 110, the electronic device 120, and/or a combination thereof obtain local sensor data 403 associated with the physical environment 105. For example, the local sensor data 403 includes images or a stream thereof of the physical environment 105, simultaneous location and mapping (SLAM) information for the physical environment 105 and the location of the electronic device 120 or the user 150 relative to the physical environment 105, ambient lighting information for the physical environment 105, ambient audio information for the physical environment 105, acoustic information for the physical environment 105, dimensional information for the physical environment 105, semantic labels for objects within the physical environment 105, and/or the like. In some implementations, the local sensor data 403 includes un-processed or post-processed information.

Similarly, as shown in FIG. 4A, one or more remote sensors 404 associated with the optional remote input devices within the physical environment 105 obtain remote sensor data 405 associated with the physical environment 105. For example, the remote sensor data 405 includes images or a stream thereof of the physical environment 105, SLAM information for the physical environment 105 and the location of the electronic device 120 or the user 150 relative to the physical environment 105, ambient lighting information for the physical environment 105, ambient audio information for the physical environment 105, acoustic information for the physical environment 105, dimensional information for the physical environment 105, semantic labels for objects within the physical environment 105, and/or the like. In some implementations, the remote sensor data 405 includes un-processed or post-processed information.

According to some implementations, the privacy architecture 408 ingests the local sensor data 403 and the remote sensor data 405. In some implementations, the privacy architecture 408 includes one or more privacy filters associated with user information and/or identifying information. In some implementations, the privacy architecture 408 includes an opt-in feature where the electronic device 120 informs the user 150 as to what user information and/or identifying information is being monitored and how the user information and/or the identifying information will be used. In some implementations, the privacy architecture 408 selectively prevents and/or limits the input processing architecture 400 or portions thereof from obtaining and/or transmitting the user information. To this end, the privacy architecture 408 receives user preferences and/or selections from the user 150 in response to prompting the user 150 for the same. In some implementations, the privacy architecture 408 prevents the input processing architecture 400 from obtaining and/or transmitting the user information unless and until the privacy architecture 408 obtains informed consent from the user 150. In some implementations, the privacy architecture 408 anonymizes (e.g., scrambles, obscures, encrypts, and/or the like) certain types of user information. For example, the privacy architecture 408 receives user inputs designating which types of user information the privacy architecture 408 anonymizes. As another example, the privacy architecture 408 anonymizes certain types of user information likely to include sensitive and/or identifying information, independent of user designation (e.g., automatically).

According to some implementations, the eye tracking engine 412 obtains the local sensor data 403 and the remote sensor data 405 after it has been subjected to the privacy architecture 408. In some implementations, the eye tracking engine 412 obtains (e.g., receives, retrieves, or determines/generates) an eye tracking vector 413 (sometimes also referred to herein as the “gaze vector 413”) based on the input data and updates the eye tracking vector 413 over time.

FIG. 4A shows an example data structure for the eye tracking vector 413 in accordance with some implementations. As shown in FIG. 4A, the eye tracking vector 413 may correspond to an N-tuple characterization vector or characterization tensor that includes a timestamp 481 (e.g., the most recent time the eye tracking vector 413 was updated), one or more angular values 482 for a current gaze direction (e.g., roll, pitch, and yaw values), one or more translational values 484 for the current gaze direction (e.g., x, y, and z values relative to the physical environment 105, the world-at-large, and/or the like), and/or miscellaneous information 486. One of ordinary skill in the art will appreciate that the data structure for the eye tracking vector 413 in FIG. 4A is merely an example that may include different information portions in various other implementations and be structured in myriad ways in various other implementations.

For example, the gaze direction indicates a point (e.g., associated with x, y, and z coordinates relative to the physical environment 105 or the world-at-large), a physical object, or a region of interest (ROI) in the physical environment 105 at which the user 150 is currently looking. As another example, the gaze direction indicates a point (e.g., associated with x, y, and z coordinates relative to the XR environment 128), an XR object, or a region of interest (ROI) in the XR environment 128 at which the user 150 is currently looking.

According to some implementations, the head/body pose tracking engine 414 obtains the local sensor data 403 and the remote sensor data 405 after it has been subjected to the privacy architecture 408. In some implementations, the head/body pose tracking engine 414 obtains (e.g., receives, retrieves, or determines/generates) a pose characterization vector 415 based on the input data and updates the pose characterization vector 415 over time.

FIG. 4A shows an example data structure for the pose characterization vector 415 in accordance with some implementations. As shown in FIG. 4A, the pose characterization vector 415 may correspond to an N-tuple characterization vector or characterization tensor that includes a timestamp 491 (e.g., the most recent time the pose characterization vector 415 was updated), a head pose descriptor 492A (e.g., upward, downward, neutral, etc.), translational values for the head pose 492B, rotational values for the head pose 492C, a body pose descriptor 494A (e.g., standing, sitting, prone, etc.), translational values for body sections/extremities/limbs/joints 494B, rotational values for the body sections/extremities/limbs/joints 494C, and/or miscellaneous information 496. In some implementations, the pose characterization vector 415 also includes information associated with finger/hand/extremity tracking. One of ordinary skill in the art will appreciate that the data structure for the pose characterization vector 415 in FIG. 4A is merely an example that may include different information portions in various other implementations and be structured in myriad ways in various other implementations.

FIG. 4B is a block diagram of an example content delivery architecture 475 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the content delivery architecture 475 is included in a computing system such as the controller 110 shown in FIGS. 1 and 2; the electronic device 120 shown in FIGS. 1 and 3; and/or a suitable combination thereof.

In some implementations, the wake logic 425 determines whether the eye tracking vector 413 and/or the pose characterization vector 415 satisfy first and second wake criteria for transitioning the electronic device 120 from a first mode (e.g., sleep mode) to a second mode (e.g., awake/active mode). According to a determination that the eye tracking vector 413 and/or the pose characterization vector 415 satisfy first and second wake criteria, the wake logic 425 may provide a mode transition indicator to the content manager 430. For example, while operating according to the first mode, the computing system executes a first plurality of functions or applications (e.g., some sensors, programs, processes, etc. may be disabled or limited). Continuing with this example, while operating according to the second mode, the computing system executes a second plurality of functions or applications greater than the first plurality of functions of applications.

According to some implementations, the interaction handler 420 obtains (e.g., receives, retrieves, or detects) one or more user inputs 421 provided by the user 150 that are associated with selecting A/V content, one or more VAs, and/or XR content for presentation. For example, the one or more user inputs 421 correspond to a gestural input selecting XR content from a UI menu detected via hand/extremity tracking, an eye gaze input selecting XR content from the UI menu detected via eye tracking, a voice command selecting XR content from the UI menu detected via a microphone, and/or the like. In some implementations, the content selector 422 selects XR content based on one or more user inputs 421 (e.g., a voice command, a selection from a menu of XR content items, and/or the like).

In various implementations, the content manager 430 manages and updates the layout, setup, structure, and/or the like for the XR environment 128, including one or more of VAs, XR content, one or more UI elements associated with the XR content, and/or the like, based on the mode transition indicator from the wake logic 425, (optionally) the one or more user inputs 421, and/or the like. To that end, the content manager 430 includes the frame buffer 434, the content updater 436, and the feedback engine 438.

In some implementations, the frame buffer 434 includes XR content, a rendered image frame, and/or the like for one or more past instances and/or frames. In some implementations, the content updater 436 modifies the XR environment 128 over time based on the mode transition indicator from the wake logic 425, the user inputs 421 associated with modifying and/or manipulating the XR content or VA(s), translational or rotational movement of objects within the physical environment 105, translational or rotational movement of the electronic device 120 (or the user 150), and/or the like. In some implementations, the feedback engine 438 generates sensory feedback (e.g., visual feedback such as text or lighting changes, audio feedback, haptic feedback, etc.) associated with the XR environment 128.

According to some implementations, the pose determiner 452 determines a current camera pose of the electronic device 120 and/or the user 150 relative to the XR environment 128 and/or the physical environment 105 based at least in part on the pose characterization vector 415. In some implementations, the renderer 454 renders the VA(s), the XR content, one or more UI elements associated with the XR content, and/or the like according to the current camera pose relative thereto.

According to some implementations, the optional image processing architecture 462 obtains an image stream from an image capture device 370 including one or more images of the physical environment 105 from the current camera pose of the electronic device 120 and/or the user 150. In some implementations, the image processing architecture 462 also performs one or more image processing operations on the image stream such as warping, color correction, gamma correction, sharpening, noise reduction, white balance, and/or the like. In some implementations, the optional compositor 464 composites the rendered XR content with the processed image stream of the physical environment 105 from the image processing architecture 462 to produce rendered image frames of the XR environment 128. In various implementations, the presenter 470 presents the rendered image frames of the XR environment 128 to the user 150 via the one or more displays 312. One of ordinary skill in the art will appreciate that the optional image processing architecture 462 and the optional compositor 464 may not be applicable for fully virtual environments (or optical see-through scenarios).

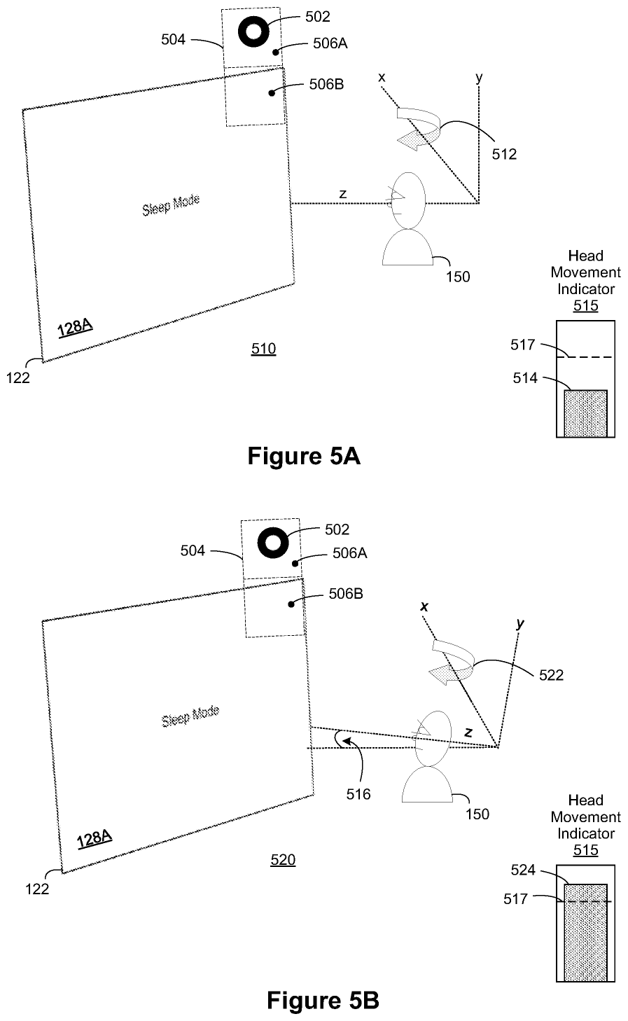

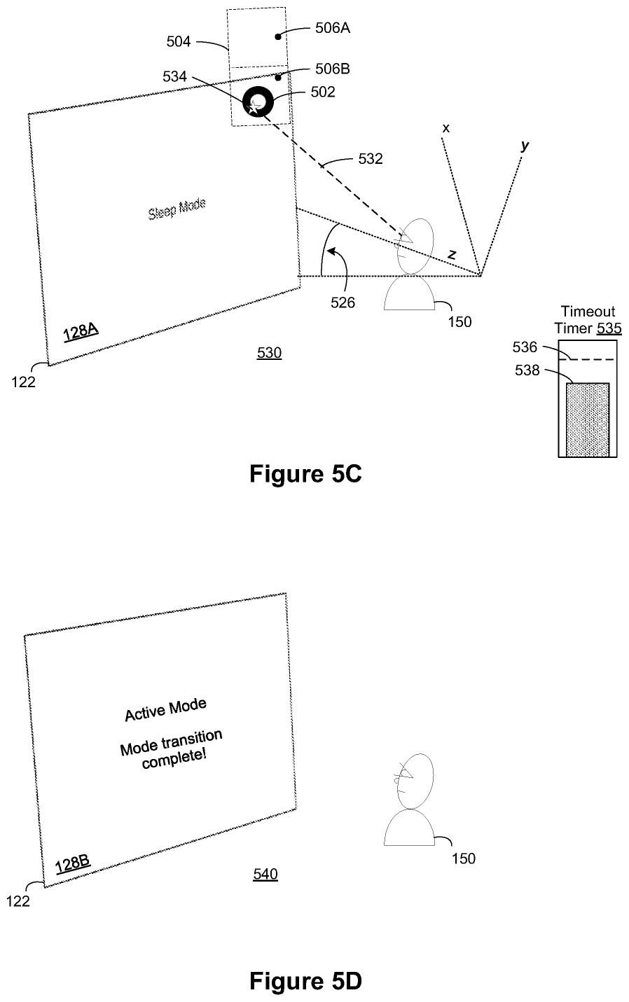

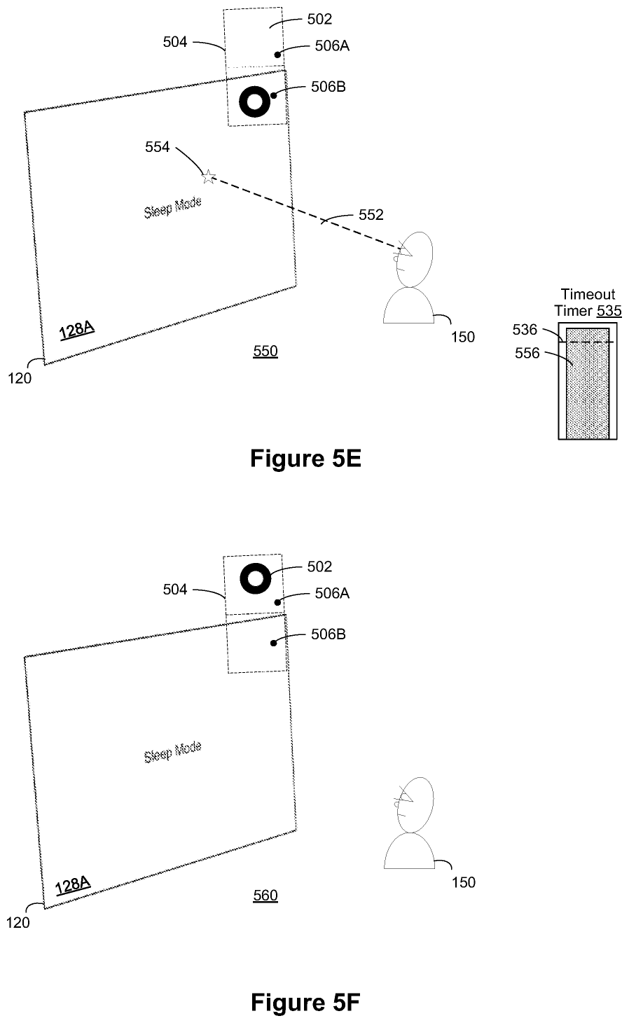

FIGS. 5A-5D illustrate a sequence of instances 510-540 in which a computing system is transitioned from a first mode to a second mode in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, the sequence of instances 510-540 are rendered and presented by a computing system such as the controller 110 shown in FIGS. 1 and 2; the electronic device 120 shown in FIGS. 1 and 3; and/or a suitable combination thereof.

For example, as shown in FIGS. 5A-5D, the sequence of instances 510-540 include a physical environment 105 and an XR environment 128A/128B presented on the display 122 of the electronic device 120 (e.g., associated with the user 150). The electronic device 120 presents, via the display 122, the XR environment 128A/128B to the user 150 while the user 150 is physically present within the physical environment 105. As such, in some implementations, the user 150 holds the electronic device 120 in their hand(s) similar to the operating environment 100 in FIG. 1. In other words, in some implementations, the electronic device 120 is configured to present XR content (e.g., virtual content) and to enable optical see-through or video pass-through of at least a portion of the physical environment 105 on the display 122. For example, the electronic device 120 corresponds to a mobile phone, tablet, laptop, near-eye system, wearable computing device, or the like.

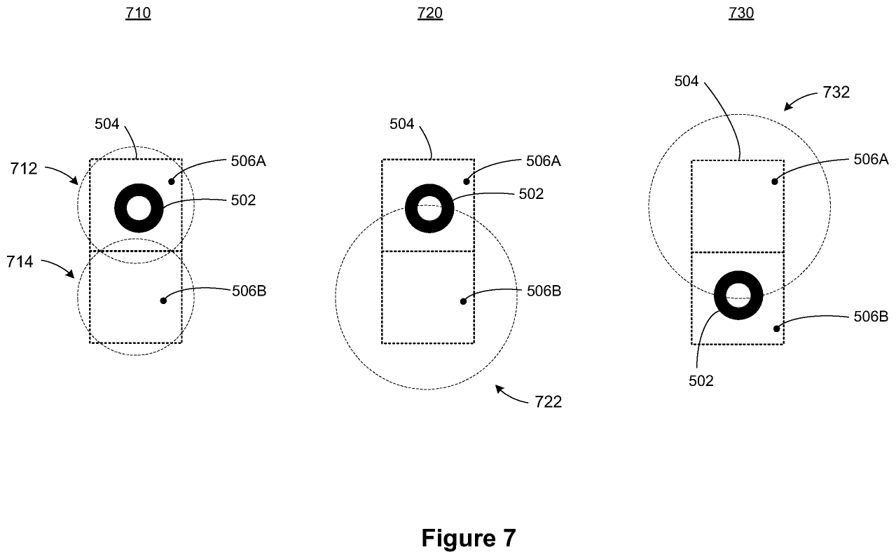

As shown in FIGS. 5A-5D, a wake target 502 is constrained within a wake region 504 that includes an off-screen sub-region 506A and an on-screen sub-region 506B. The wake region 504 is described in more detail below with reference to FIG. 7. In FIG. 5A, the wake target 502 is located within the off-screen sub-region 506A and is not presented on the display 122. According to some implementations, the wake target 502 corresponds to three-dimensional (3D) or volumetric XR content. In some implementations, the electronic device 120 presents at least a portion of the wake region 504 and/or the on-screen sub-region 506B on the display 122. In some implementations, the electronic device 120 does not present the wake region 504 or the on-screen sub-region 506B on the display 122.

With reference to FIG. 5A, during the instance 510 (e.g., associated with time T₁), while operating in a first mode (e.g., sleep mode), the electronic device 120 presents a first XR environment (or UI) 128A with an (optional) indication of the first mode (e.g., an icon associated with the sleep mode, text indicating “sleep mode”, haptic feedback, audible feedback, and/or the like). During the instance 510, the electronic device 120 detects a head movement 512 of the user 150 about an X-axis relative to the display 122 (e.g., upward pitch rotation) based at least in part on a change in the eye tracking vector 413 and/or the pose characterization vector 415.

FIG. 5A shows a head movement indicator 515 with a head movement value 514 (e.g., N degrees of upward pitch rotation) associated with the head movement 512 relative to a rest/origin head pose. One of ordinary skill in the art will appreciate that the head movement indicator 515 may or not be presented on the display 122 in various implementations. As shown in FIG. 5A, the head movement value 514 is less than a head movement threshold value 517. In some implementations, the head movement threshold value 517 corresponds to a deterministic or non-deterministic value such as X degrees of upward pitch rotation or the like. In some implementations, the head movement indicator 515 may be associated with head velocity, acceleration, jerk, etc. instead of or in addition to head movement (e.g., angular displacement). For example, the velocity and/or acceleration of the head movement alone or in combination with the angular displacement of the head movement could be used to determine whether to bring the wake target 502 into view. Continuing with this example, this would prevent long, slow head rotations from unintentionally satisfying the first wake criterion.

According to some implementations, the electronic device 120 determines whether the head movement 512 satisfies a first wake criterion. With reference to FIG. 5A, the electronic device 120 determines that the head movement 512 does not satisfy the first wake criterion because the head movement value 514 associated with the head movement 512 does not exceed the head movement threshold value 517. In some implementations, in accordance with a determination that the head movement 512 does not satisfy the first wake criterion, the electronic device 120 does not present the wake target 502 within the on-screen sub-region 506B as shown in FIG. 5B. In some implementations, in accordance with a determination that the head movement 512 satisfies the first wake criterion, the electronic device 120 presents the wake target 502 within the on-screen sub-region 506B as shown in FIG. 5C.

With reference to FIG. 5B, during the instance 520 (e.g., associated with time T 2), while operating in the first mode (e.g., sleep mode), the electronic device 120 maintains the wake target 502 within the off-screen sub-region 506A in accordance with the determination that the first wake criterion was not satisfied in FIG. 5A. As shown in FIG. 5B, the display 122 has shifted by an offset value 516 relative to the user 150 as compared to FIG. 5A due to the head movement 512 in FIG. 5A.

During the instance 520, the electronic device 120 detects a head movement 522 of the user 150 about the X-axis relative to the display 122 based at least in part on a change in the eye tracking vector 413 and/or the pose characterization vector 415 associated with the user 150. FIG. 5B shows the head movement indicator 515 with a head movement value 524 (e.g., M degrees of upward pitch rotation) associated with the head movements 512 and 522 relative to the rest/origin head pose. As shown in FIG. 5B, the head movement value 524 is greater than the head movement threshold value 517.

According to some implementations, the electronic device 120 determines whether the head movement 522 satisfies the first wake criterion. With reference to FIG. 5B, the electronic device 120 determines that the head movement 522 satisfies the first wake criterion because the head movement value 524 associated with the head movements 512 and 522 exceeds the head movement threshold value 517.

With reference to FIG. 5C, during the instance 530 (e.g., associated with time T 3), while operating in the first mode (e.g., sleep mode), the electronic device 120 presents the wake target 502 within the on-screen sub-region 506B in accordance with the determination that the first wake criterion was satisfied in FIG. 5B. As shown in FIG. 5C, the display 122 has shifted by an offset value 526 relative to user 150 as compared to FIG. 5A due to the head movement 512 in FIG. 5A and the head movement 522 in FIG. 5B.

During the instance 530, the electronic device 120 determines a gaze vector 532 of the user 150 and a gaze intersection 534 relative to the display 122 based at least in part on the eye tracking vector 413 and/or the pose characterization vector 415 associated with the user 150. In some implementations, the electronic device 120 presents a visual representation of at least a portion of the gaze vector 532 and/or the gaze intersection 534 on the display 122. In some implementations, the electronic device 120 does not present the visual representation of the gaze vector 532 or the gaze intersection 534 on the display 122. In some implementations, the gaze tracking is not performed until the first wake criterion is satisfied based on the head pose information in order to save power and other resources.

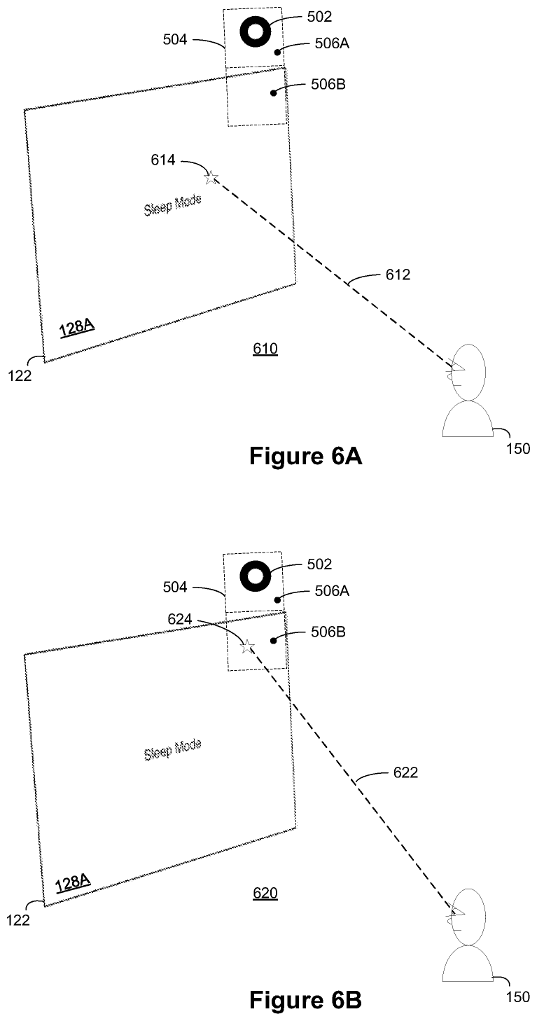

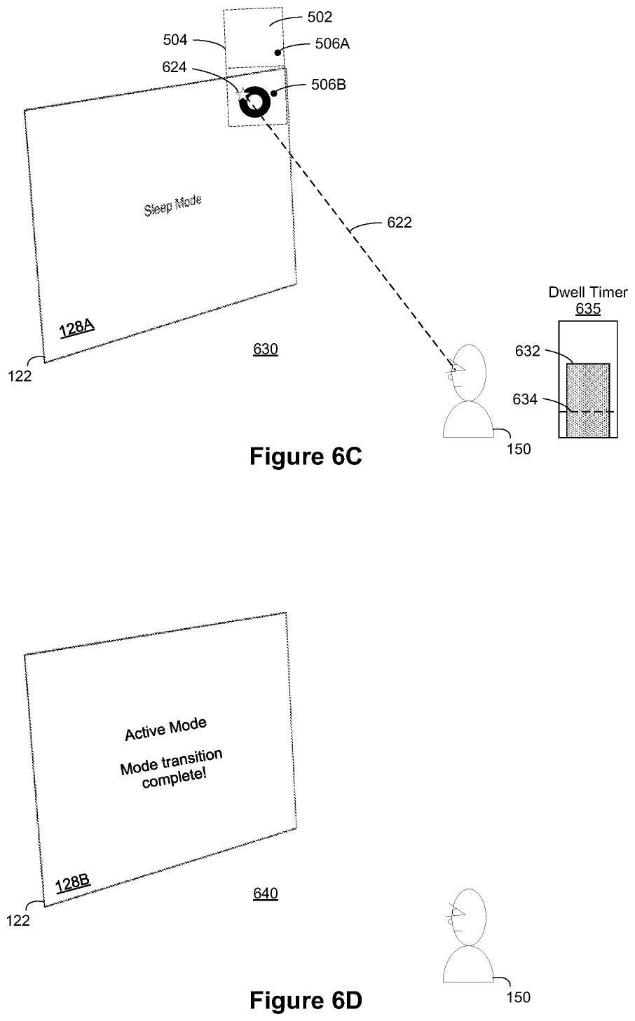

According to some implementations, the electronic device 120 determines whether the gaze vector 532 satisfies a second wake criterion. As one example, the second wake criterion is satisfied when the gaze vector 532 is directed to the wake target 502 or at least a portion of the on-screen sub-region 506B before a timeout timer 535 exceeds a deterministic or non-deterministic timeout threshold 536 (e.g., 5 seconds). As another example, the second wake criterion is satisfied when the gaze vector 532 is directed to the wake target 502 or at least a portion of the on-screen sub-region 506B for at least a deterministic or non-deterministic dwell threshold 634 (e.g., 1 second) shown in FIG. 6C before the timeout timer 535 exceeds the deterministic or non-deterministic timeout threshold 536. As shown in FIG. 5C, the gaze intersection 534 of the gaze vector 532 is directed to the wake target 502 at current time 538, which does not exceed the timeout threshold 536. As such, the gaze vector 532 satisfies the second wake criterion in FIG. 5C.

With reference to FIG. 5D, during the instance 540 (e.g., associated with time T 4), the electronic device 120 transitions from the first mode to a second mode (e.g., awake/active mode) in accordance with a determination that the second wake criterion was satisfied in FIG. 5C. During the instance 540, while operating in the second mode, the electronic device 120 presents a second XR environment (or UI) 128B with an (optional) indication of the second mode (e.g., an icon associated with the active mode, text indicating “active mode”, haptic feedback, audible feedback, and/or the like).

During the instance 540, in response to transitioning to the second mode, the electronic device 120 ceases presentation of the wake target 502 and also optionally ceases presentation of the wake region 504. As one example, the wake target 502 fades out of the on-screen sub-region 506B in FIG. 5D. As another example, an animation removes the wake target 502 from the on-screen sub-region 506B in FIG. 5D. As yet another example, the wake target 502 moves or floats up-and-out of the on-screen sub-region 506B in FIG. 5D.

FIGS. 5A, 5B, 5E, and 5F illustrate another sequence of instances 510, 520, 550, and 560 in which the computing system stays in the first mode in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, the sequence of instances 510, 520, 550, and 560 are rendered and presented by a computing system such as the controller 110 shown in FIGS. 1 and 2; the electronic device 120 shown in FIGS. 1 and 3; and/or a suitable combination thereof. FIGS. 5E and 5F are similar to and adapted from FIGS. 5A-5D. As such, similar reference numbers are used therein and only the differences will be described for the sake of brevity.

With reference to FIG. 5E, during the instance 550 (e.g., associated with time T₅), the electronic device 120 presents the wake target 502 within the on-screen sub-region 506B in accordance with a determination that the first wake criterion was satisfied in FIG. 5B. During the instance 550, the electronic device 120 determines a gaze vector 552 of the user 150 and a gaze intersection 554 relative to the display 122 based at least in part on the eye tracking vector 413 and/or the pose characterization vector 415 associated with the user 150. In some implementations, the electronic device 120 presents a visual representation of at least a portion of the gaze vector 552 and/or the gaze intersection 554 on the display 122. In some implementations, the electronic device 120 does not present the visual representation of the gaze vector 552 or the gaze intersection 554 on the display 122.

According to some implementations, the electronic device 120 determines whether the gaze vector 552 satisfies a second wake criterion. As one example, the second wake criterion is satisfied when the gaze vector 552 is directed to the wake target 502 or at least a portion of the on-screen sub-region 506B before the timeout timer 535 exceeds the deterministic or non-deterministic timeout threshold 536 (e.g., 5 seconds). As another example, the second wake criterion is satisfied when the gaze vector 552 is directed to the wake target 502 or at least a portion of the on-screen sub-region 506B for at least the deterministic or non-deterministic dwell threshold 634 (e.g., 1 second) shown in FIG. 6C before the timeout timer 535 exceeds the deterministic or non-deterministic timeout threshold 536. As shown in FIG. 5E, the gaze intersection 554 of the gaze vector 552 is not directed to the wake target 502 or the on-screen sub-region 506B. Furthermore, in FIG. 5E, the current time 556 exceeds the timeout threshold 536. As such, the gaze vector 552 does not satisfy the second wake criterion in FIG. 5E.

With reference to FIG. 5F, during the instance 560 (e.g., associated with time T₆), the electronic device 120 remains in the first mode (e.g., sleep mode) in accordance with a determination that the second wake criterion was not satisfied in FIG. 5E. During the instance 560, while continuing to operate in the first mode, the electronic device 120 maintains presentation of the first XR environment (or UI) 128A with the (optional) indication of the first mode.

During the instance 560, the electronic device 120 ceases presentation of the wake target 502 within the on-screen sub-region 506B in accordance with the determination that the second wake criterion has not been satisfied in FIG. 5E. As shown in FIG. 5F, the wake target 502 is located within the off-screen sub-region 506A similar to FIG. 5A. As one example, the wake target 502 fades out of the on-screen sub-region 506B in FIG. 5F. As another example, an animation removes the wake target 502 from the on-screen sub-region 506B in FIG. 5F. As yet another example, the wake target 502 moves or floats up-and-out of the on-screen sub-region 506B in FIG. 5F.

FIGS. 6A-6D illustrate yet another sequence of instances 610-640 in which the computing system is transitioned from a first mode to a second mode in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as anon-limiting example, the sequence of instances 610-640 are rendered and presented by a computing system such as the controller 110 shown in FIGS. 1 and 2; the electronic device 120 shown in FIGS. 1 and 3; and/or a suitable combination thereof. FIGS. 6A-6D are similar to and adapted from FIGS. 5A-5D. As such, similar reference numbers are used therein and only the differences will be described for the sake of brevity.

With reference to FIG. 6A, during the instance 610 (e.g., associated with time T₁), while operating in a first mode (e.g., sleep mode), the electronic device 120 presents a first XR environment (or UI) 128A with an (optional) indication of the first mode (e.g., an icon associated with the sleep mode, text indicating “sleep mode”, haptic feedback, audible feedback, and/or the like). During the instance 610, the electronic device 120 determines a gaze vector 612 of the user 150 and a gaze intersection 614 relative to the display 122 based at least in part on the eye tracking vector 413 and/or the pose characterization vector 415 associated with the user 150. In some implementations, the electronic device 120 presents a visual representation of at least a portion of the gaze vector 612 and/or the gaze intersection 614 on the display 122. In some implementations, the electronic device 120 does not present the visual representation of the gaze vector 612 or the gaze intersection 614 on the display 122.

According to some implementations, the electronic device 120 determines whether the gaze vector 612 satisfies a first wake criterion. As one example, the first wake criterion is satisfied when the gaze intersection 614 of the gaze vector 612 is directed to or overlaps at least a portion of the on-screen sub-region 506B. As shown in FIG. 6A, the gaze intersection 614 is not directed to and does not overlap the on-screen sub-region 506B. As such, the gaze vector 612 does not satisfy the first wake criterion in FIG. 6A.

With further reference to FIG. 6A, the electronic device 120 detects a rotational gaze movement (e.g., a change to the eye tracking vector 413) about XY-axes relative to the eyes of the user 150. With reference to FIG. 6B, during the instance 620 (e.g., associated with time T₂), the electronic device 120 maintains operating in the first mode in accordance with a determination that the gaze vector 612 does not satisfy the first wake criterion in FIG. 6A.

During the instance 620, the electronic device 120 determines a gaze vector 622 of the user 150 and a gaze intersection 624 relative to the display 122 based at least in part on the eye tracking vector 413 and/or the pose characterization vector 415 associated with the user 150 in response to detecting the rotational gaze movement in FIG. 6A. In some implementations, the electronic device 120 presents a visual representation of at least a portion of the gaze vector 622 and/or the gaze intersection 624 on the display 122. In some implementations, the electronic device 120 does not present the visual representation of the gaze vector 622 or the gaze intersection 624 on the display 122.

According to some implementations, the electronic device 120 determines whether the gaze vector 622 satisfies the first wake criterion. As one example, the first wake criterion is satisfied when the gaze intersection 624 of the gaze vector 622 is directed to or overlaps at least a portion of the on-screen sub-region 506B. As shown in FIG. 6B, the gaze intersection 624 is directed to the on-screen sub-region 506B. As such, the gaze vector 622 satisfies the first wake criterion in FIG. 6B.

With reference to FIG. 6C, during the instance 630 (e.g., associated with time T₃), the electronic device 120 presents the wake target 502 within the on-screen sub-region 506B in accordance with a determination that the first wake criterion was satisfied in FIG. 6B. During the instance 630, the electronic device 120 determines whether the gaze vector 622 satisfies a second wake criterion.

As one example, the second wake criterion is satisfied when the gaze vector 622 is directed to the wake target 502 or at least a portion of the on-screen sub-region 506B for at least a deterministic or non-deterministic dwell threshold 634 (e.g., 1 second). As another example, the second wake criterion is satisfied when the gaze vector 622 is directed to the wake target 502 or at least a portion of the on-screen sub-region 506B before the timeout timer 535 exceeds a deterministic or non-deterministic timeout threshold 536 (e.g., 5 seconds) shown in FIG. 5C. As another example, the second wake criterion is satisfied when the gaze vector 622 is directed to the wake target 502 or at least a portion of the on-screen sub-region 506B for at least a deterministic or non-deterministic dwell threshold 634 before the timeout timer 535 exceeds the deterministic or non-deterministic timeout threshold 536 shown in FIG. 5C.

As shown in FIG. 6C, the gaze intersection 624 of the gaze vector 622 is directed to the wake target 502. Furthermore, in FIG. 6C, the gaze vector 622 has been directed to the wake target 502 for a current dwell time 632 (illustrated relative to a dwell timer 635) that exceeds the dwell threshold 634. As such, the gaze vector 622 satisfies the second wake criterion in FIG. 6C because the gaze vector 622 is directed to the wake target 502 for at least the dwell threshold 634.

With reference to FIG. 6D, during the instance 640 (e.g., associated with time T₄), the electronic device 120 transitions from the first mode to a second mode (e.g., awake/active mode) in accordance with a determination that the second wake criterion was satisfied in FIG. 6C. During the instance 640, while operating in the second mode, the electronic device 120 presents a second XR environment (or UI) 128B with an (optional) indication of the second mode (e.g., an icon associated with the active mode, text indicating “active mode”, haptic feedback, audible feedback, and/or the like).

During the instance 640, in response to transitioning to the second mode, the electronic device 120 ceases presentation of the wake target 502 and also optionally ceases presentation of the wake region 504. As one example, the wake target 502 fades out of the on-screen sub-region 506B in FIG. 6D. As another example, an animation removes the wake target 502 from the on-screen sub-region 506B in FIG. 6D. As yet another example, the wake target 502 moves or floats up-and-out of the on-screen sub-region 506B in FIG. 6D.

FIG. 7 illustrates various attractor scenarios 710-730 associated with the wake region 504 in FIGS. 5A-5F and 6A-6D in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, the attractor scenarios 710-730 include attractor areas that correspond to simulated magnetic fields with deterministic or non-deterministic magnetic field strength values (H) and deterministic or non-deterministic magnetic flux density values (B).

As shown in FIG. 7, the wake region 504 includes the off-screen sub-region 506A and the on-screen sub-region 506B. The wake target 502 is constrained by the wake region 504. In the attractor scenarios 710-730, the wake target 502 is located in either the off-screen sub-region 506A or the on-screen sub-region 506B depending on the current mode (e.g., the first or second mode), user context information (e.g., the current eye tracking vector 413, the current pose characterization vector 415, and/or a change thereto), and/or satisfaction of the first or second wake criteria.

As shown in scenario 710, the wake region 504 is associated with weak attractor areas 712 and 714 that constrain the movement of the wake target 502 and maintain the location of the wake target 502 relative to the center of the off-screen sub-region 506A and the on-screen sub-region 506B, respectively. As described above, in some implementations, the weak attractor areas 712 and 714 corresponds to simulated magnetic fields that attract/repel the wake target 502.

As shown in scenario 720, the wake region 504 is associated with a first strong attractor area 722 when the wake target 502 is located in the off-screen sub-region 506A. For example, when the first wake criterion is satisfied, the wake target 502 moves from the off-screen sub-region 506A to the on-screen sub-region 506B (e.g., the sequence of instances 520 to 530, or the sequence of instances 620 to 630) based on activation/instantiation of the first strong attractor area 722. As described above, in some implementations, the first strong attractor area 722 corresponds to a simulated magnetic field that attracts the wake target 502. According to some implementations, the weak attractor areas 712 and 714 may be active while the first strong attractor area 722 is active.

As shown in scenario 730, the wake region 504 is associated with a second strong attractor area 732 when the wake target 502 is located in the on-screen sub-region 506B. For example, when the second wake criterion is not satisfied (or the timeout threshold 536 has been exceeded), the wake target 502 moves from the on-screen sub-region 506B to the off-screen sub-region 506A wake target 502 moves from the off-screen sub-region 506A to the on-screen sub-region 506B (e.g., the sequence of instances 550 to 560) based on activation/instantiation of the second strong attractor area 732. As described above, in some implementations, the second strong attractor area 732 corresponds to a simulated magnetic field that attracts the wake target 502. According to some implementations, the weak attractor areas 712 and 714 may be active while the second strong attractor area 732 is active.

According to some implementations, the first strong attractor area 722 and the second strong attractor area 732 are larger and stronger than the weak attractor areas 712 and 714. In implementations, the first strong attractor area 722 and the second strong attractor area 732 have the same size and strength but different locations relative to the wake region 504.

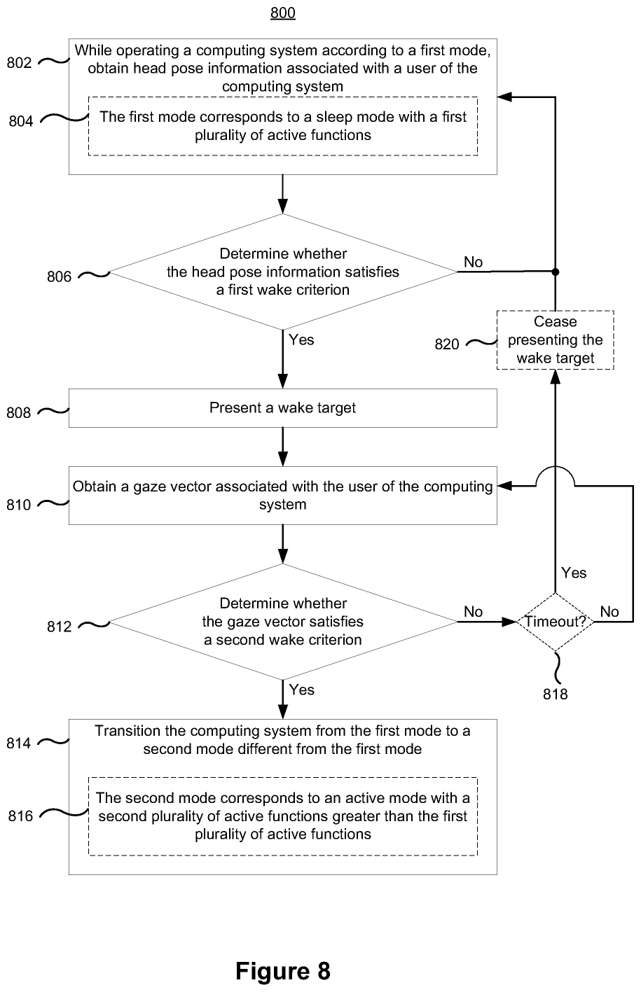

FIG. 8 illustrates a flowchart representation of a method 800 of transitioning from a sleep mode to an active mode in accordance with some implementations. In various implementations, the method 800 is performed at a computing system including non-transitory memory and one or more processors, wherein the computing system is communicatively coupled to a display device and one or more input devices (e.g., the electronic device 120 shown in FIGS. 1 and 3; the controller 110 in FIGS. 1 and 2; or a suitable combination thereof). In some implementations, the method 800 is performed by processing logic, including hardware, firmware, software, or a combination thereof. In some implementations, the method 800 is performed by a processor executing code stored in a non-transitory computer-readable medium (e.g., a memory). In some implementations, the computing system corresponds to one of a tablet, a laptop, a mobile phone, a near-eye system, a wearable computing device, or the like. In some implementations, the one or more input devices correspond to a computer vision (CV) engine that uses an image stream from one or more exterior-facing image sensors, a finger/hand/extremity tracking engine, an eye tracking engine, a touch-sensitive surface, one or more microphones, and/or the like.

As discussed above, maintaining a computing system in a constant active state generates thermal load, consumes computing and memory resources, and also drains power/battery reserves. As such, the computing system may enter a lower-power state, such as a sleep or suspended state, after some period of inactivity. A wake input may trigger a transition from the lower-power state to a higher-power state. Typical wake inputs may correspond to a predefined voice input or the like, which may still require some sensors to remain active. In contrast to above, the method described herein includes a two-step wake heuristic for transitioning from the sleep mode to the active by firstly leveraging motion sensor data (e.g., IMU, accelerometer, gyroscope, magnetometer, etc.) related to head/body pose and secondly employing eye tracking as a confirmation input.

As represented by block 802, while operating the computing system according to a first mode, the method 800 includes obtaining (e.g., receiving, retrieving, generating, determining, etc.) head pose information associated with a user of the computing system. In some implementations, as represented by block 804, the first mode corresponds to a sleep mode with a first plurality of active functions. For example, with reference to FIG. 5A, the electronic device 120 presents a first XR environment (or UI) 128A with the (optional) indication of the first mode (e.g., an icon associated with the sleep mode, text indicating “sleep mode”, haptic feedback, audible feedback, and/or the like). Continuing with this example, with reference to FIG. 5A, the electronic device 120 obtains head pose information based at least in part on the eye tracking vector 413 and/or the pose characterization vector 415 associated with the user 150.

As one example, with reference to FIGS. 4A and 4B, the computing device or a portion thereof (e.g., the head/body pose tracking engine 414) obtains (e.g., receives, retrieves, or determines/generates) a pose characterization vector 415 and updates the pose characterization vector 415 over time in response to detecting changes to the head/body pose of the user 150. In some implementations, obtaining the pose characterization vector 415 corresponds to generating the pose characterization vector 415 based on sensor data collected by the computing system. In some implementations, the sensor data is collected by a combination of optional remote sensors, the electronic device 120, and the controller 110. As shown in FIG. 4A, for example, the input processing architecture 400 generates the pose characterization vector 415 based on the local sensor data 403 and/or the remote sensor data 405.

As represented by block 806, the method 800 includes determining whether the head pose information satisfies a first wake criterion. According to some implementations, the first wake criterion is satisfied when the pose information (or a change thereto) indicates that head movement (e.g., head pitch rotation) satisfies a head movement threshold value as shown in FIGS. 5A-5C. In some implementations, the first wake criterion is also satisfied when the gaze vector is directed to the wake region as described above with reference to FIGS. 6A-6C.

According to some implementations, the first wake criterion is satisfied when the pose information indicates that a field-of-view (FOV) of the user overlaps at least a portion of a wake region of the display device. For example, the electronic device 120 determines/generates the FOV of the user 150 relative to the display 122 based at least in part on the eye tracking vector 413 and/or the pose characterization vector 415 associated with the user 150. As one example, when the electronic device 120 corresponds to a head-mounted system, the entirety of the display 122 may be within the FOV of the user 150. As another example, when the electronic device 120 corresponds to a tablet or a mobile phone, a portion of the display 122 may be within the FOV of the user 150. In some implementations, the FOV of the user corresponds to a rectangular bounding region relative to a centroid associated with a head of the user of the computing system. In some implementations, the FOV of the user corresponds to a circular bounding region with a predefined radius of pixels relative to a centroid associated with a head of the user of the computing system.

According to a determination that the head pose information (or the change thereto) satisfies the first wake criterion (e.g., the “Yes” branch from block 806), the method 800 continues to block 808. As one example, with reference to FIG. 5B, the electronic device 120 determines whether the head movement 522 satisfies a first wake criterion. With reference to FIG. 5B, the electronic device 120 determines that the head movement 522 satisfies the first wake criterion because the head movement value 524 associated with the head movements 512 and 522 exceeds the head movement threshold value 517. In some implementations, in accordance with a determination that the head movement 512 satisfies the first wake criterion, the electronic device 120 presents the wake target 502 within the on-screen sub-region 506B as shown in FIG. 5C.

As another example, with reference to FIG. 6B, the electronic device 120 determines whether the gaze vector 622 satisfies the first wake criterion. For example, the first wake criterion is satisfied when the gaze intersection 624 of the gaze vector 622 is directed to or overlaps at least a portion of the on-screen sub-region 506B. As shown in FIG. 6B, the gaze intersection 624 is directed to the on-screen sub-region 506B. As such, the gaze vector 622 satisfies the first wake criterion in FIG. 6B.

According to a determination that the head pose information (or a change thereto) does not satisfy the first wake criterion (e.g., the “No” branch from block 806), the method 800 repeats block 802. In some implementations, in accordance with a determination that the head pose information does not satisfy the first wake criterion, the method 800 includes forgoing presentation of the wake target and maintaining operation of the computing system in the first mode. As one example, with reference to FIG. 5A, the electronic device 120 determines whether the head movement 512 satisfies a first wake criterion. With reference to FIG. 5A, the electronic device 120 determines that the head movement 512 does not satisfy the first wake criterion because the head movement value 514 associated with the head movement 512 does not exceed the head movement threshold value 517A. In some implementations, in accordance with a determination that the head movement 512 does not satisfy the first wake criterion, the electronic device 120 does not present the wake target 502 within the on-screen sub-region 506B as shown in FIG. 5B.

As another example, with reference to FIG. 6A, the electronic device 120 determines whether the gaze vector 612 satisfies a first wake criterion. For example, the first wake criterion is satisfied when the gaze intersection 614 of the gaze vector 612 is directed to or overlaps at least a portion of the on-screen sub-region 506B. As shown in FIG. 6A, the gaze intersection 614 is not directed to and does not overlap the on-screen sub-region 506B. As such, the gaze vector 612 does not satisfy the first wake criterion in FIG. 6A.

As represented by block 808, the method 800 includes presenting, via the display device, a wake target. As one example, with reference to FIG. 5C, the electronic device 120 presents the wake target 502 within the on-screen sub-region 506B in accordance with a determination that the first wake criterion was satisfied in FIG. 5B. As another example, with reference to FIG. 6C, the electronic device 120 presents the wake target 502 within the on-screen sub-region 506B in accordance with a determination that the first wake criterion was satisfied in FIG. 6B.

In some implementations, the wake target corresponds to virtual content overlaid on a physical environment. In some implementations, the wake target corresponds to virtual content composited with an image frame of a physical environment. In some implementations, the wake target corresponds to volumetric or three-dimensional (3D) virtual content. In some implementations, the display device corresponds to a transparent lens assembly, and wherein presenting the wake target includes projecting the wake target onto the transparent lens assembly. In some implementations, the display device corresponds to a near-eye system, and wherein presenting the wake target includes compositing the wake target with one or more images of a physical environment captured by an exterior-facing image sensor.

As represented by block 810, the method 800 includes obtaining (e.g., receiving, retrieving, generating, determining, etc.) a gaze vector associated with the user of the computing system. As one example, with reference to FIG. 5C, the electronic device 120 determines a gaze vector 532 of the user 150 and a gaze intersection 534 relative to the display 122 based at least in part on the eye tracking vector 413 and/or the pose characterization vector 415 associated with the user 150. In some implementations, the electronic device 120 presents a visual representation of at least a portion of the gaze vector 532 and/or the gaze intersection 534 on the display 122. In some implementations, the electronic device 120 does not present the visual representation of the gaze vector 532 or the gaze intersection 534 on the display 122.

As another example, with reference to FIGS. 6B and 6C, the electronic device 120 determines a gaze vector 622 of the user 150 and a gaze intersection 624 relative to the display 122 based at least in part on the eye tracking vector 413 and/or the pose characterization vector 415 associated with the user 150 in response to detecting the rotational gaze movement in FIG. 6A. In some implementations, the electronic device 120 presents a visual representation of at least a portion of the gaze vector 622 and/or the gaze intersection 624 on the display 122. In some implementations, the electronic device 120 does not present the visual representation of the gaze vector 622 or the gaze intersection 624 on the display 122.

For example, with reference to FIGS. 4A and 4B, the computing device or a portion thereof (e.g., the eye tracking engine 412) obtains (e.g., receives, retrieves, or determines/generates) an eye tracking vector 413 and updates the eye tracking vector 413 over time in response to detecting changes to the gaze direction of the user 150. In some implementations, obtaining the eye tracking vector 413 corresponds to generating the pose eye tracking vector 413 based on sensor data collected by the computing system. In some implementations, the sensor data is collected by a combination of optional remote sensors, the electronic device 120, and the controller 110. As shown in FIG. 4A, for example, the input processing architecture 400 generates the eye tracking vector 413 based on the local sensor data 403 and/or the remote sensor data 405.

As represented by block 812, the method 800 includes determining whether the gaze vector satisfies a second wake criterion. As one example, the gaze vector satisfies the second wake criterion when the gaze vector is directed to the wake target. As another example, the gaze vector satisfies the second wake criterion when the gaze vector is directed to a rectangular N×M pixel area surrounding the wake target. As another example, the gaze vector satisfies the second wake criterion when the gaze vector is directed to a circular R radius pixel area surrounding the wake target.

As yet another example, the gaze vector satisfies the second wake criterion when the gaze vector is directed to the wake target before a timeout timer exceeds a predefined timeout threshold. For example, the predefined timeout threshold corresponds to a deterministic or non-deterministic amount of time. As yet another example, the gaze vector satisfies the second wake criterion when the gaze vector is directed to the wake target for at least a predefined dwell threshold. For example, the predefined dwell threshold corresponds to a deterministic or non-deterministic amount of time. As yet another example, the gaze vector satisfies the second wake criterion when the gaze vector is directed to the wake target for at least a predefined dwell threshold before a timeout timer exceeds a predefined timeout threshold.

According to a determination that the gaze vector satisfies the second wake criterion (e.g., the “Yes” branch from block 812), the method 800 continues to block 814. As one example, with reference to FIG. 5C, the electronic device 120 determines whether the gaze vector 532 satisfies a second wake criterion. As shown in FIG. 5C, the gaze intersection 534 of the gaze vector 532 is directed to the wake target 502 at current time 538, which does not exceed the timeout threshold 536. As such, the gaze vector 532 satisfies the second wake criterion in FIG. 5C.

As another example, with reference to FIG. 6C, the electronic device 120 determines whether the gaze vector 622 satisfies a second wake criterion. As shown in FIG. 6C, the gaze intersection 624 of the gaze vector 622 is directed to the wake target 502. Furthermore, in FIG. 6C, the gaze vector 622 has been directed to the wake target 502 for a current dwell time 632 (illustrated relative to a dwell timer 635) that exceeds the dwell threshold 634. As such, the gaze vector 622 satisfies the second wake criterion in FIG. 6C because the gaze vector 622 is directed to the wake target 502 for at least the dwell threshold 634.

According to a determination that the gaze vector does not satisfy the second wake criterion (e.g., the “No” branch from block 812), the method 800 continues to block 818. In some implementations, in accordance with a determination that the gaze vector does not satisfy the second wake criterion, the method 800 includes ceasing presentation of the wake target and maintaining operation of the computing system in the first mode. For example, the computing system ceases presentation of the wake target by floating the wake target off the display 122. In another example, the computing system ceases presentation of the wake target by fading the wake target out of the display 122. In yet another example, the computing system ceases presentation of the wake target by displaying an animation that removes the wake target from the display 122.

As one example, with reference to FIG. 5E, the electronic device 120 determines whether the gaze vector 552 satisfies a second wake criterion. As shown in FIG. 5E, the gaze intersection 554 of the gaze vector 552 is not directed to the wake target 502 or the on-screen sub-region 506B. Furthermore, in FIG. 5E, the current time 556 exceeds the timeout threshold 536. As such, the gaze vector 552 does not satisfy the second wake criterion in FIG. 5E.

As represented by block 814, the method 800 includes transitioning the computing system from the first mode to a second mode different from the first mode. In some implementations, as represented by block 816, the second mode corresponds to an active mode with a second plurality of active functions greater than the first plurality of active functions.

As one example, with reference to FIG. 5D, the electronic device 120 transitions from the first mode to a second mode (e.g., awake/active mode) in accordance with a determination that the second wake criterion was satisfied in FIG. 5C. With continued reference to FIG. 5D, while operating in the second mode, the electronic device 120 presents a second XR environment (or UI) 128B with the (optional) indication of the second mode (e.g., an icon associated with the active mode, text indicating “active mode”, haptic feedback, audible feedback, and/or the like).

Continuing with the above example, in response to transitioning to the second mode, the electronic device 120 ceases presentation of the wake target 502 and also optionally ceases presentation of the wake region 504 in FIG. 5D. As one example, the wake target 502 fades out of the on-screen sub-region 506B in FIG. 5D. As another example, an animation removes the wake target 502 from the on-screen sub-region 506B in FIG. 5D. As yet another example, the wake target 502 moves or floats up-and-out of the on-screen sub-region 506B in FIG. 5D.

As another example, with reference to FIG. 6D, the electronic device 120 transitions from the first mode to a second mode (e.g., awake/active mode) in accordance with a determination that the second wake criterion was satisfied in FIG. 6C. With continued reference to FIG. 6D, while operating in the second mode, the electronic device 120 presents a second XR environment (or UI) 128B with the (optional) indication of the second mode (e.g., an icon associated with the active mode, text indicating “active mode”, haptic feedback, audible feedback, and/or the like).

Continuing with the above example, in response to transitioning to the second mode, the electronic device 120 ceases presentation of the wake target 502 and also optionally ceases presentation of the wake region 504 in FIG. 6D. As one example, the wake target 502 fades out of the on-screen sub-region 506B in FIG. 6D. As another example, an animation removes the wake target 502 from the on-screen sub-region 506B in FIG. 6D. As yet another example, the wake target 502 moves or floats up-and-out of the on-screen sub-region 506B in FIG. 6D.

According to some implementations, as represented by block 818, the method 800 includes determining whether a timeout period has elapsed. According to a determination that the timeout period has elapsed (e.g., the “Yes” branch from block 818), the method 800 continues to block 820. According to a determination that the timeout period has not elapsed (e.g., the “No” branch from block 818), the method 800 continues to block 810. For example, with reference to FIG. 5E, the current time 556 exceeds the timeout threshold 536. In other words, the timeout period has elapsed in FIG. 5E.

According to some implementations, as represented by block 820, the method 800 includes ceasing presentation of the wake target. In some implementations, the method 800 continues to block 802 after completion of block 820. As one example, with reference to FIG. 5F, the electronic device 120 remains in the first mode (e.g., sleep mode) in accordance with a determination that the second wake criterion was not satisfied and the timeout period has elapsed in FIG. 5E. With further reference to FIG. 5F, while continuing to operate in the first mode, the electronic device 120 maintains presentation of the first XR environment (or UI) 128A with the (optional) indication of the first mode.

Continuing with the above example, the electronic device 120 ceases presentation of the wake target 502 within the on-screen sub-region 506B in FIG. 5F in accordance with the determination that the second wake criterion has not been satisfied in FIG. 5E. As shown in FIG. 5F, the wake target 502 is located within the off-screen sub-region 506A similar to FIG. 5A. As one example, the wake target 502 fades out of the on-screen sub-region 506B in FIG. 5F. As another example, an animation removes the wake target 502 from the on-screen sub-region 506B in FIG. 5F. As yet another example, the wake target 502 moves or floats up-and-out of the on-screen sub-region 506B in FIG. 5F.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first”, “second”, etc. may be used herein to describe various elements, these elements should not be limited by these terms. These terms are only used to distinguish one element from another. For example, a first media item could be termed a second media item, and, similarly, a second media item could be termed a first media item, which changing the meaning of the description, so long as the occurrences of the “first media item” are renamed consistently and the occurrences of the “second media item” are renamed consistently. The first media item and the second media item are both media items, but they are not the same media item.

The terminology used herein is for the purpose of describing particular implementations only and is not intended to be limiting of the claims. As used in the description of the implementations and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a computing system including non-transitory memory and one or more processors, wherein the computing system is communicatively coupled to a display device and one or more input devices:
while operating the computing system according to a first mode, obtaining head pose information associated with a user of the computing system;
in accordance with a determination that the head pose information satisfies a first wake criterion:
presenting, via the display device, a wake target; and
obtaining a gaze vector associated with the user of the computing system; and
in accordance with a determination that the gaze vector satisfies a second wake criterion, transitioning the computing system from the first mode to a second mode different from the first mode.

2. The method of claim 1, wherein the head pose information satisfies the first wake criterion when a head movement value associated with a change to the head pose information exceeds a head movement threshold.

3. The method of claim 1, further comprising:
in accordance with a determination that the head pose information does not satisfy the first wake criterion:
forgoing presentation of the wake target; and
maintaining operation of the computing system in the first mode.

4. The method of claim 1, further comprising:
in accordance with a determination that the gaze vector does not satisfy the second wake criterion:
ceasing presentation of the wake target; and
maintaining operation of the computing system in the first mode.

5. The method of claim 1, wherein the first mode corresponds to a sleep mode with a first plurality of active functions, and wherein the second mode corresponds to an active mode with a second plurality of active functions greater than the first plurality of active functions.

6. The method of claim 1, wherein the first wake criterion is satisfied when the pose information indicates that a field-of-view (FOV) of the user overlaps at least a portion of a wake region of the display device.

7. The method of claim 6, wherein the FOV of the user corresponds to a rectangular bounding region relative to a centroid associated with a head of the user of the computing system.

8. The method of claim 6, wherein the FOV of the user corresponds to a circular bounding region with a predefined radius of pixels relative to a centroid associated with a head of the user of the computing system.

9. The method of claim 1, wherein the second wake criterion is satisfied when the gaze vector is directed to the wake target.

10. The method of claim 1, wherein the second wake criterion is satisfied when the gaze vector is directed to the wake target before a timeout timer exceeds a predefined timeout threshold.

11. The method of claim 1, wherein the second wake criterion is satisfied when the gaze vector is directed to the wake target for at least a predefined dwell threshold.

12. The method of claim 1, wherein the second wake criterion is satisfied when the gaze vector is directed to the wake target for at least a predefined dwell threshold before a timeout timer exceeds a predefined timeout threshold.

13. The method of claim 1, wherein the wake target corresponds to virtual content overlaid on a physical environment.

14. The method of claim 1, wherein the wake target corresponds to virtual content composited with an image frame of a physical environment.

15. The method of claim 1, wherein the wake target corresponds to volumetric or three-dimensional (3D) virtual content.

16. A device comprising:
one or more processors;
a non-transitory memory;
an interface for communicating with a display device and one or more input devices; and
one or more programs stored in the non-transitory memory, which, when executed by the one or more processors, cause the device to:
while operating the computing system according to a first mode, obtain head pose information associated with a user of the computing system;
in accordance with a determination that the head pose information satisfies a first wake criterion:
present, via the display device, a wake target; and
obtain a gaze vector associated with the user of the computing system; and
in accordance with a determination that the gaze vector satisfies a second wake criterion, transition the computing system from the first mode to a second mode different from the first mode.

17. The device of claim 16, wherein the head pose information satisfies the first wake criterion when a head movement value associated with a change to the head pose information exceeds a head movement threshold.

18. The device of claim 16, wherein the one or more programs further cause the device to:
in accordance with a determination that the head pose information does not satisfy the first wake criterion:
forgo presentation of the wake target; and
maintain operation of the computing system in the first mode.

19. The device of claim 16, wherein the one or more programs further cause the device to:
in accordance with a determination that the gaze vector does not satisfy the second wake criterion:
cease presentation of the wake target; and
maintain operation of the computing system in the first mode.

20. A non-transitory memory storing one or more programs, which, when executed by one or more processors of a device with an interface for communicating with a display device and one or more input devices, cause the device to:
while operating the computing system according to a first mode, obtain head pose information associated with a user of the computing system;
in accordance with a determination that the head pose information satisfies a first wake criterion:
present, via the display device, a wake target; and
obtain a gaze vector associated with the user of the computing system; and
in accordance with a determination that the gaze vector satisfies a second wake criterion, transition the computing system from the first mode to a second mode different from the first mode.

21. The non-transitory memory of claim 20, wherein the head pose information satisfies the first wake criterion when a head movement value associated with a change to the head pose information exceeds a head movement threshold.

22. The non-transitory memory of claim 20, wherein the one or more programs further cause the device to:
in accordance with a determination that the head pose information does not satisfy the first wake criterion:
forgoing presentation of the wake target; and
maintaining operation of the computing system in the first mode.

23. The-transitory memory of claim 20, wherein the one or more programs further cause the device to:
in accordance with a determination that the gaze vector does not satisfy the second wake criterion:
cease presentation of the wake target; and
maintain operation of the computing system in the first mode.
